(19) United States
(12) Patent Application Publication
(10) Pub. No.: US 2011/0238242 A1
(43) Pub. Date: Sep. 29, 2011

(54) SYNCHRONIZATION TO ADJACENT WIRELESS NETWORKS USING SINGLE RADIO

(75) Inventor: KEVIN CHRISTOPHER NICHTER, Prospect, KY (US)

(73) Assignee: INVENSYS RAIL CORPORATION, Louisville, KY (US)

(21) Appl. No.: 12/749,377

(22) Filed: Mar. 29, 2010

(51) Int. Cl. G05D 1/00

(52) U.S. Cl. 701/19

(57) ABSTRACT

A train communication system is provided for enabling communications between wayside hubs and trains operating on a track. Each wayside hub includes a block processor and at least one hub radio, with the block processor and hub radio connected via a first network. The wayside hubs are interconnected through a second network. Each train includes a train radio connected to a train control system. The block processor transmits information to the train control systems via the hub radio. If a hub includes more than one hub radio, one is selected to act as a master hub to coordinate reception and transmission of messages between the block processor and the train radios within radio range of the hub radios. Synchronization information is exchanged between an upcoming hub and a current hub for a train upon determination that the train is approaching a boundary between the hubs.

### BACKGROUND

Automated train control systems are being utilized with increased frequency in the U.S. and in other countries around the world, both for freight and for passenger rail systems. In the U.S., recent legislation requires the installation of a positive train control (PTC) system on Class 1 freight rail lines and all tracks carrying passenger trains by 2016. These automated train control systems may be passive systems in which a human operator is primarily responsible for controlling movement of the train and which only act to prevent unsafe operation of the train, such as when a human operator attempts to move a train faster than an applicable speed limit or beyond a section of track in which the train is authorized to travel. Automated systems may also be of the active variety which are primarily responsible for controlling movement of the train and a human operator only acts when necessary to ensure proper operation of the train.

A common feature of many of such automated train control systems is the need for constant or nearly constant communications between onboard train control systems and an offboard hub radio connected to control equipment located along the wayside or in a central office. In some systems, the offboard control equipment generates movement authorities which authorize the train to move in one or more sections of track, sometimes referred to as blocks. In some systems, the offboard equipment informs the onboard train control system of the presence of other trains in the vicinity. In yet other systems, the offboard equipment provides information such as temporary speed restrictions and work zone information to the onboard train control system. Those of skill in the art will recognize that a wide variety of such automated control systems are possible.

The ability to maintain constant or near constant communications between a train traveling along a track and a wayside device is complicated by several factors. Because trains are mobile, it is necessary to use omnidirectional antennas onboard the trains rather than directional antennas. The use of omnidirectional antennas results in lower fade margin that would be possible if directional antennas could be used. Using omnidirectional antennas also exposes the radio receiver to more interfering sources. Also, because the trains are mobile, the transceivers onboard the train may become physically isolated from a transceiver located offboard the train, such as when the train movement results in the presence of an obstruction (e.g., a topographical feature) between the train's transceiver and a transceiver located offboard the train. Movement of the trains also results in variable multipath effects that affect radio reception.

Some systems address the aforementioned issues using a “cluster hub” technique in which multiple, geographically dispersed redundant offboard transceivers connected via a typically wired local area network (a “LAN”) act together under the control of a master transceiver in the cluster (sometimes referred to as a master hub) to form a radio hub for communication with the mobile radios onboard the trains. One such system is the AR24027 Cluster Hub Point to Multi-Point (PmP) system from AFAR Communications Inc.

In a typical railroad system, two or more of these cluster hub networks will exist side-by-side along the track, with each cluster hub being responsible for providing the train with control information in a corresponding area of the track. Each of these cluster hubs typically operate on different channels, and the onboard mobile radios are responsible for changing channels and disconnecting from one cluster hub and connecting to the next cluster hub as the train travels along the track. In order to achieve the high degree of radio connectivity discussed above, existing onboard train control systems employ two onboard radios in a “make before break” scheme in which one of the onboard radios makes a connection to an upcoming cluster hub in an overlap region between adjacent cluster hubs before the other onboard radio breaks an existing connection with the current cluster hub.

### BRIEF DESCRIPTION OF THE DRAWINGS

FIG. 1 is a block diagram of a train communication system employing a cluster hub technique according to one embodiment

FIG. 2 is a flowchart of a synchronization process according to one embodiment.

FIG. 3 is a block diagram of a train communication system according to another embodiment.

FIG. 4 is a flowchart of a method for obtaining synchronization information for a train according to an additional embodiment.

FIG. 5 is a flowchart of a method for communicating synchronization information for a train according to yet another embodiment.

### DETAILED DESCRIPTION

In the following detailed description, a plurality of specific details, such as types and operational frequencies of radios, communications protocols, and types and sequences of messages, are set forth in order to provide a thorough understanding of the preferred embodiments discussed below. The details discussed in connection with the preferred embodiments should not be understood to limit the present inventions. Furthermore, for ease of understanding, certain method steps are delineated as separate steps; however, these steps should not be construed as necessarily distinct nor order dependent in their performance.

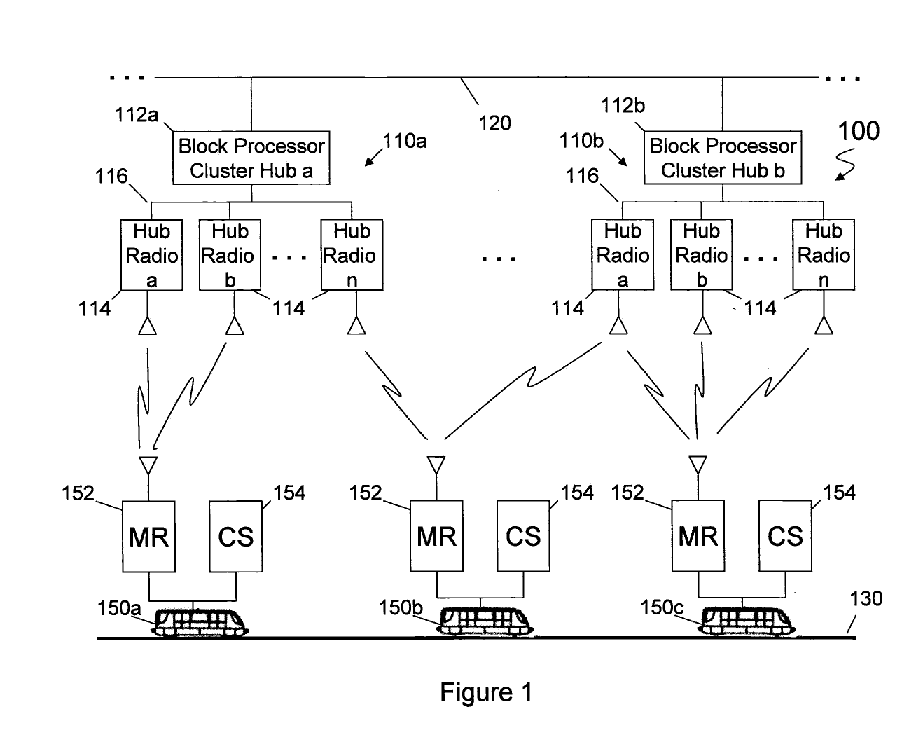

A train communication system 100 is illustrated in FIG. 1. The communication system 100 includes a plurality of cluster hubs 110, each comprising a block processor 112 and a plurality of hub radios 114a-n connected to each other via a LAN 116. The block processor 112 may be a single device or a plurality of devices, and may include any system known or hereafter developed for transmitting train control information of any kind to an onboard train control system. Examples include but are not limited to dispatching systems and central office control systems as well as distributed wayside control systems in which individual devices are responsible for controlling the movement of trains in a respective block of track associated with the cluster 110.

The hub radios 114 may be realized using any suitable transceiver. In some embodiments, the hub radios 114 are realized using Safetran A53325 ethernet Spread Spectrum Radios (“eSSRs”), which are direct sequence spread spectrum transceivers that operate in the 2.4 GHz band. In such embodiments, the LAN 116 is a wired, 100 MHz Ethernet LAN.

A second wired network 120 connects block processors 112. The network 120 may be an Internet network, a dedicated, special purpose connection, an Ethernet WAN/LAN/CAN, satellite, licensed or unlicensed radio frequency transceivers, a PSTN connection, cellular, fiber, or any other type of network or combination of networks capable of carrying data between the block processors 112. Those of skill in the art will recognize that the second network 120 may connect hub radios 114 (e.g., the master hub radios) rather than block processors 112 in respective cluster hubs 110, and that first and second networks 116, 120 may be a single network in yet other embodiments, in which case both block processors and hub radios 114 in the various cluster hubs 110 would be connected.

Also shown in FIG. 1 are a plurality of trains 150a-c on a track 130, each of which includes a mobile radio 152 connected to a train control system 154. In some embodiments, the mobile radios 152 are also Safetran A53325 eSSRs. As shown in FIG. 1, train 150a is currently within radio range of hub radios 114a and 114b of cluster hub a, train 150b is currently within radio range of hub radio 114n of cluster hub a and hub radio 114a of cluster hub b, and train 150c is currently within radio range of hubs 114a, 114b and 114n of cluster hub b. It should be understood that any number of trains 150 may be within radio range of hubs 114 in a cluster hub 110, and such trains may be within radio range of one, some, or all of the hubs 114 within a cluster hub 110.

The communications system 100 is designed to provide a reliable communication network between the block processors 112 (which are responsible for issuing train control commands such as movement authorities and speed restrictions for the trains 150), all wayside hub radios 114 (which are responsible for distribution of train control commands), and all trains 150 in a corresponding cluster 110. All of the radios 114, 152 in a cluster operate in a time division multiplex mode, with each radio transmitting during a pre-allocated time slot in a repeating time cycle. The overall time cycle is divided into an outbound phase during which all hub radios 114 transmit, and an inbound phase during which all mobile radios 152 transmit. Each radio is assigned zero, one or more time slots during which it may transmit in a cycle, based on demand.

One of the hub radios 114 in a cluster hub 110 acts as a master hub. The selection of a master hub may be static or dynamic, may be autonomous or directed, and may be automatic or manual. In some embodiments, the hubs 114 perform an autonomous selection process in which all hubs 114 transmit a packet with their serial numbers and the hub 114 with the highest serial number is selected to act as the master hub. Thus, different hubs 114 in the cluster 110 may act as the master hub at different times. The master hub is responsible for, among other things, scheduling the TDM cycle by assigning transmission slots in the cycle to the hubs 114 and remote radios 152, and transmitting a heartbeat message over the LAN 116 once per cycle to which all other hubs 114 in the cluster hub 110 synchronize.

In addition to this low level synchronization, in some embodiments the master hub is responsible for coordinating the reception and transmission of packets between the block processor 112 and the mobile radios 152 onboard the trains 150. For outbound packets from the block processor 112 to a mobile radio 152, the master hub acts as a distributor. The master hub 114 receives all packets sent from the block processor 112 (or any other device in the cluster which sends data to the train) over the LAN 116. The master hub maintains a table of all mobile radios 152 in the cluster 110 and the identity of the hubs 114 with the strongest received signal strength indicators (“RSSIs”), and selects one or more of the hubs 114 to transmit a packet on the basis of the RSSIs. The master hub then appends a header including a sequence number and an indicator of each of the hubs 114 that are to broadcast the packet to the mobile radios 152 (because the train is moving and its position relative to the hubs 114 may have changed since its last transmission, multiple hubs 114 are selected to transmit a single packet). The master hub then multicasts the packet with the appended header to each of the hubs 114 that is to broadcast the packet. When the transmitted packets are received at a mobile radio 152, the mobile radio 152 discards duplicate packets before transmitting the received packet to the onboard control system 154.

For inbound packets transmitted from the mobile radios 152, the master hub acts as an aggregator. Multiple hubs 114 may receive any one packet transmitted by a mobile radio 152. Each of the packets transmitted by a mobile radio 152 includes a header with a packet sequence number. Each of the hubs 114 forwards all received packets to the master hub. The master hub then discards duplicate copies of the packet before forwarding the packet on to the block processor 112.

In some embodiments, packets transmitted to or from the block processor 112 may be broken down into fragments. For inbound packet fragments received from a mobile radio 152, the master hub 114 discards duplicate fragments and assembles the packet before forwarding it to the block processor 112. For outbound packet fragments received from the block processor 112, the mobile radios 152 discard duplicate fragments and perform the packet assembly function.

As shown in FIG. 1, multiple cluster hubs 110 are present along the track 130. Each of the hubs 114 in a cluster hub 110 transmit on the same channel, but different channels are used in each of the cluster hubs 110. Existing systems known to the inventors deal with this issue by utilizing two mobile radios 152 on each train 150 so that one radio may ascertain the correct channel and establish communications with a cluster hub 110 (i.e., obtain a direct sequence code for use in the new cluster, and obtain train control information such as authorities or information about the presence of other trains in the upcoming section of track associated with the cluster) before the other radio breaks communications with the cluster hub 110 that the train is leaving. This solution has the disadvantage of requiring two radios, which increases the overall cost of a train communication system.

An alternative solution that utilizes a single radio functions by having a train obtain synchronization information from an upcoming cluster over a hub 114 in an existing cluster using the wired connection 120 between clusters. Thus, for example, a train 150b that is in cluster 110a but within radio range of 110b, or even a train 150 that is not yet within radio range of cluster 110b, can receive train control information from block processor 112b and/or radio synchronization information from one of the hubs 114 in cluster 110b (e.g., the master hub 114 of cluster hub 110b) via the wired connection 120 and a wireless connection with one of the hubs 114 in cluster hub 110a. By obtaining synchronization information for an upcoming cluster hub 110b in advance of breaking communications with the current cluster hub 110a, the “down time” between the moment that radio communications with the existing cluster is broken and radio communications are established and/or sufficient train control information is received for the upcoming cluster hub 110b is kept to a minimum. This minimization of down time makes the single radio 152 solution acceptable.

In some embodiments, the hubs 114 acting as the master hubs in their respective clusters 110 are also in charge of facilitating such communications between clusters. In other words, the master hubs act as gateways through which requests for information to or from devices (radio hubs, block processors, or any other devices) in other clusters are routed. It should be understood, however, that devices other than the master hubs may perform this gateway function. In other embodiments, the block processors 112 perform this gateway function. In yet other embodiments, other devices (not shown in the figures) separate from either the block processors 112 or the hubs 114 perform this gateway function.

There are several methods by which the initiation of the transmission of the synchronization information can be triggered. These methods may be classified generally as either “push” or “pull” methods. In a pull method, the transmission of the synchronization information is initiated by the mobile radio 152, whereas the transmission of the synchronization information is initiated by one or the other of the cluster hubs 110 in a push method. Initiation of either method may be accomplished in any number of ways.

Pull Methods: In some embodiments, the train control system 154 determines its position using an onboard GPS receiver, by means of wayside transponders, or by some other means. If the train control system 154 does not include an onboard track database, the train control system 154 may send its position to a wayside device, and the wayside device may use this position and a wayside track database to determine the distance to the next cluster boundary and send a message to the onboard control system 154 to inform it that it is approaching a cluster boundary so that the onboard control system 154 can initiate the transfer of synchronization information. If the train control system 154 further includes an onboard track database, the onboard system 154 itself may determine the distance to the next cluster boundary using the position from the GPS receiver as a reference in order to determine when to start the transfer of synchronization information. As yet another example, the onboard radio 152 may utilize the detection of a transmission from a hub radio 114 in the upcoming sector to initiate the transfer of synchronization information. In such a method, it is possible to use a comparison of the RSSI for such transmission against a threshold as a trigger. Those of skill in the art will recognize that many other methods for initiating the transfer of synchronization information are possible.

Push Methods: There are also many possible ways in which synchronization information may be pushed to the train 150. This push may initiate from either the current cluster or an upcoming cluster. In some embodiments, the block processor 112 maintains the position of trains in its cluster. In such systems, the block processor 112 of the cluster hub 110 in which the train is located determines when the train is nearing a boundary and sends a message via the wired connection 120 to the cluster 110 being approached by the train. In response, the block processor 112 gathers synchronization information (which includes communicating with the master hub 114 in that cluster) and send the information to the block processor 112 in the current cluster. The block processor 112 in the current cluster 110 then passes this information to the master hub 114 in the current cluster 110 for transmission to the mobile radio 152 on the train 150.

In yet other embodiments, an upcoming cluster hub 110 senses a transmission from a mobile radio 152 on an approaching train 150. In such embodiments, the cluster hubs 110 may be assigned fixed frequencies, and a dedicated radio at the border of each cluster may listen for transmissions on the frequencies of the neighboring cluster, or the hub 114 nearest the boundaries of each cluster may periodically listen for transmissions on the frequency of the neighboring cluster. When such a transmission is detected, the associated RSSI may be compared to a threshold. If the threshold is exceeded, the radio detecting the transmission informs the master hub 114 to push synchronization information to the mobile radio 152 of the approaching train 150. Those of skill in the art will recognize that other methods of initiating the “pushing” of synchronization information are possible.

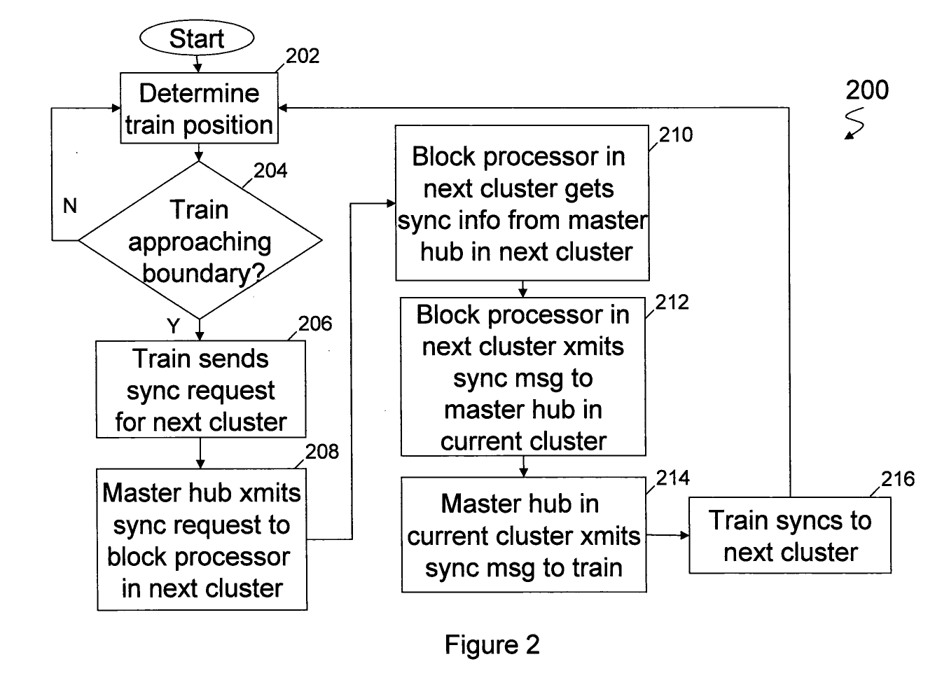

The processing performed by an exemplary system employing a “pull” technique will now be illustrated with reference to the flowchart 200 of FIG. 2. The process begins at step 202 with the onboard train control system 154 determining the position of the train. As discussed above, this may be accomplished through the use of an onboard GPS receiver in some embodiments or by any other means. At step 204, the onboard train control system 154 determines whether or not the train 150 is approaching a cluster boundary. If not, step 202 is repeated. If the train is approaching a cluster boundary, the onboard train control system 154 generates a synchronization information request message at step 206. The master hub receives this message and transmits it to the block processor 112 in the next cluster 110 at step 208.

At step 210, the block processor 112 in the next cluster 110 receives the synchronization information request message and gets radio synchronization information from the master hub in that cluster. In embodiments in which the synchronization information does not include radio synchronization information (e.g., channel number/frequency, TDMA slot assignment, direct sequence code, etc.), this step may be skipped. The block processor 112 in the next cluster then combines the radio synchronization information with train control information for the next cluster 110 (e.g., movement authorities for the train 150, temporary and/or permanent speed restrictions applicable in the upcoming cluster, positions of other trains in the area of track associated with the upcoming cluster, etc.) and transmits the synchronization information in a message to the master hub 114 in the current cluster at step 212. The master hub 114 in the current cluster relays this message to the train 150 at step 214, and the train 150 breaks communications with the current cluster and synchronizes to a hub 114 in the next cluster at step 216. The process then repeats with the next cluster as the current cluster.

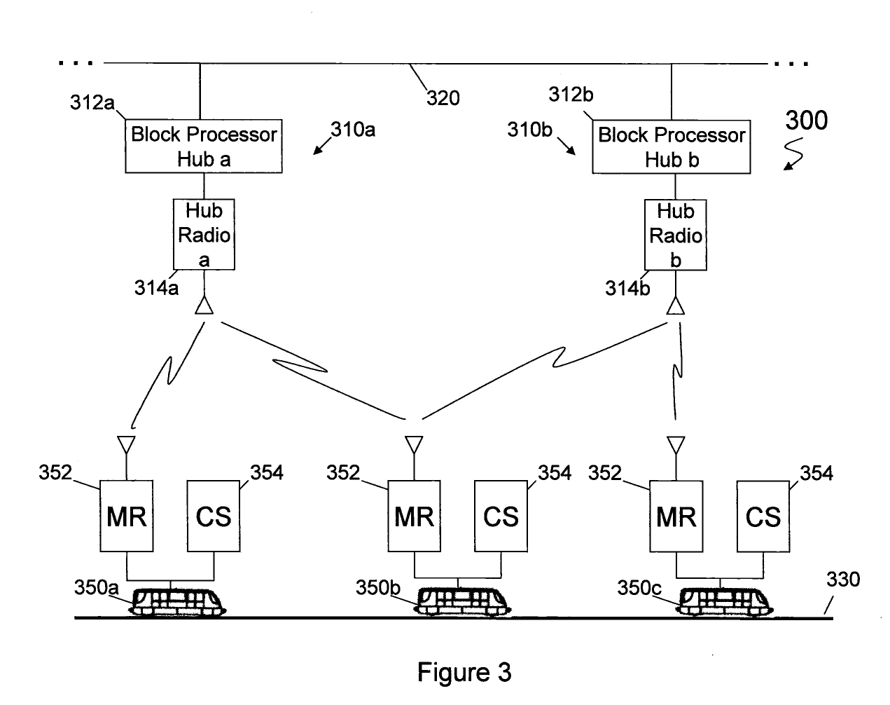

A train communication system 300, according to an additional embodiment, is illustrated in FIG. 3. The system 300 of FIG. 3 differs from the system 100 of FIG. 1 in that the system 300 employs a single hub radio, rather than clusters of hub radios, for each block processor in each section of track. The communication system 300 includes a plurality of hubs 310, each comprised of a block processor 312 and a hub radio 314. A respective hub radio 314 and block processor 312 are connected to each other via a LAN 316. A second wired network 320 connects block processors 312.

A plurality of trains 350a-c on a track 330, each of which includes a mobile radio 352 connected to a train control system 354, are also illustrated in FIG. 3. As shown in FIG. 3, train 350a is currently within radio range of hub radio 314a of hub a, train 350b is currently within radio range of hub radio 314a of hub a and hub radio 314b of hub b, and train 350c is currently within radio range of hub radio 314b of hub b. Any number of trains 350 may be within radio range of a hub radio 314 in a hub 310.

The hub radio 314 is responsible for the reception and transmission of packets between the block processor 312 and the mobile radios 352 onboard the trains 350. For outbound packets from the block processor 312 to a mobile radio 352, the hub radio 314 acts as a distributor. The hub radio 314 receives all packets sent from the block processor 312 over the LAN 316. For inbound packets transmitted from the mobile radios 352, the hub radio 314 forwards the packet on to the block processor 312.

Synchronization information is transmitted between the hubs 310 according to the push and pull methods described above with reference to system 100. Thus, the synchronization information from an upcoming hub 310 is obtained by a hub radio 314 in an existing hub using the wired connection 320 between hubs.

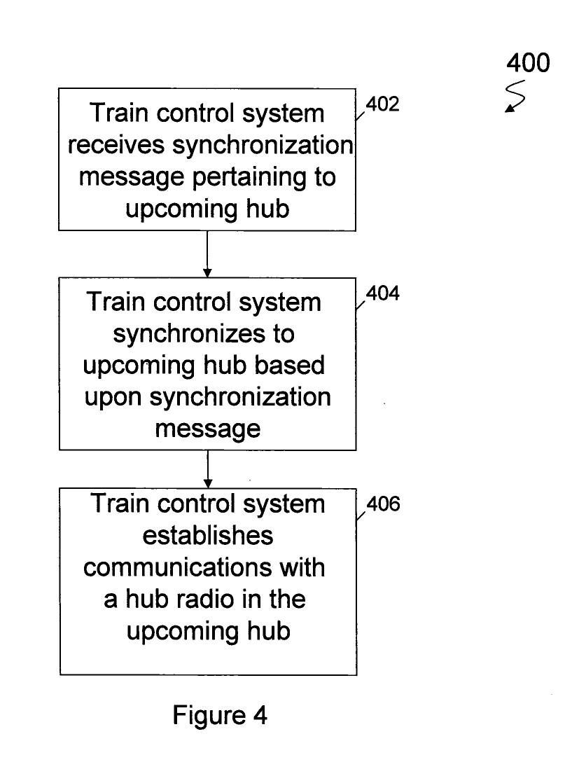

A process for obtaining synchronization information for a train is illustrated with reference to the flowchart 400 of FIG. 4. The process is performed by an onboard control system of a train 350, such as a train control system 354.

At 402, the train control system 354 receives from a hub radio 314 in a current hub 310 in which the train 350 is positioned a synchronization message that pertains to an upcoming hub 310.

At 404, the train control system 354 synchronizes to the upcoming hub 310 using relevant information contained in the synchronization message. Then, at 406, the train control system 354 establishes communications with a hub radio 314 in the upcoming hub 310.

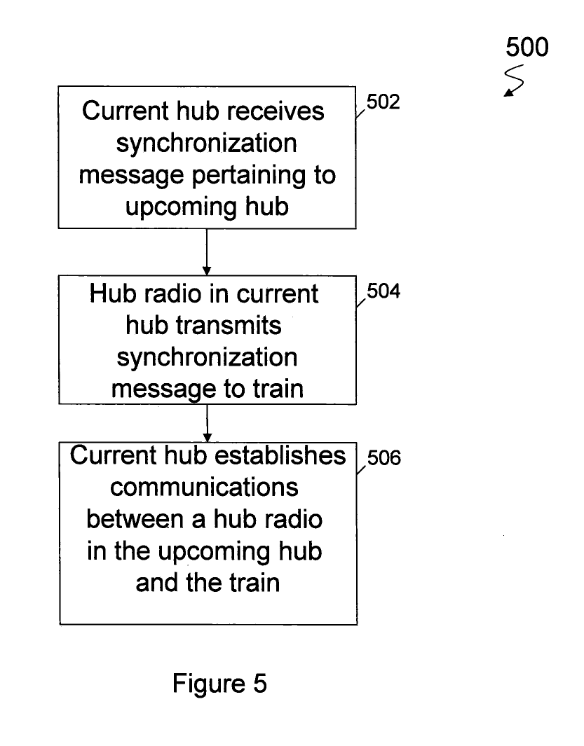

FIG. 5 provides a flowchart 500 illustrating a method for communicating synchronization information for a train 350. The process is performed by a hub 310 that includes a block processor hub 312 and a hub radio 314.

At 502, synchronization information that pertains to an upcoming hub 310 is received by a current hub 310. The current hub 310 is the hub associated with a section of the track on which the train 350 is currently positioned.

At 504, a synchronization message that includes the synchronization information received by the current hub 310 is transmitted by a hub radio 314 in the current hub 310 to the train 350. At 506, the current hub 310 establishes communications between a hub radio 314 in the upcoming hub 310 and the train 350.

The processes of obtaining synchronization information for a train and communicating synchronization information for a train as described respectively with reference to FIG. 4 and FIG. 5 may also be employed with a communication system in which a cluster of hub radios are part of a hub, such as the system 100 described above with reference to FIG. 1.

The embodiments described above were discussed primarily in the context of synchronization information. However, it should be understood that the gateway function discussed above could also be used to exchange other types of information. For example, it is becoming increasingly common for trains to provide interne access to passengers and/or crew onboard a train. The gateway function described above may be utilized to route IP packets from a user on one train to a user or a device (e.g., an Internet gateway) in a different cluster. Similarly, other types of data (e.g., video) from different clusters may be exchanged using this technique. One way in which such communications could be achieved is for the mobile train control system to send a message with an address for a device in a different cluster. The master hub (or other device performing the gateway function) recognizes that the destination address is not on the LAN 116 and forwards the message to the master hubs (or other devices performing the gateway function) on the other clusters, such as by using an agreed upon UDP port for such inter-cluster data.

The foregoing examples are provided merely for the purpose of explanation and are in no way to be construed as limiting. While reference to various embodiments is made, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

The purpose of the Abstract is to enable the patent office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present inventions in any way.

1. A train communication system for providing communications to one or more trains operating on a track, the system comprising:
a plurality of hubs, each hub comprising a block processor and a hub radio interconnected via a first network, the plurality of hubs interconnected to one another via a second network; and
one or more trains disposed on the track for movement thereon, each train comprising a train radio connected to a train control system;
wherein each block processor is configured to transmit information to one or more train control systems via the hub radio, the hub radio configured to coordinate reception and transmission of messages between the respective block processor and one or more train radios within radio range of the hub radio within the respective hub;
wherein synchronization information is exchanged between an upcoming hub and a current hub via the second network upon determination that a train is approaching a boundary between the current hub and the upcoming hub.

2. The system of claim 1, wherein the first network comprises a wired local area network (LAN).

3. The system of claim 1, wherein the second network comprises a wired connection, a wireless connection, or a combination thereof.

4. The system of claim 1, wherein the hub radios and train radios comprise transceivers configured to operate in a time division multiplex (TDM) mode.

5. The system of claim 1, wherein a train control system of a train is configured to determine if the train is approaching the boundary, and wherein the train control system requests the synchronization information through the train radio.

6. The system of claim 1, wherein a block processor of the current hub in which a train is located is configured to determine if the train is approaching the boundary, and wherein the block processor of the current hub sends a message requesting the synchronization information to the upcoming hub upon determination that the train is approaching the boundary.

7. The system of claim 1, wherein a block processor of the upcoming hub in which a train is approaching is configured to determine if the train is approaching the boundary based upon a detection of a transmission from a train radio of the train.

8. The system of claim 1, wherein the hub radio within a hub comprises a plurality of radios connected to the first network to form a cluster hub, and wherein a master hub is selected from the plurality of radios for coordinating reception and transmission of messages between the respective block processor and one or more train radios within radio range of one or more radios within the cluster hub.

9. The system of claim 8, wherein the master hub is configured to receive a packet sent from the block processor over the first network, select one or more radios in the cluster hub to which to transmit the packet, create a message comprising a header and the packet, and transmit the message to each selected radio for transmission to a train control system.

10. The system of claim 1, wherein the synchronization information comprises information for synchronizing the train radio to a radio in the upcoming hub.

11. The system of claim 1, wherein the synchronization information comprises train control information relating to the upcoming hub.

12. A method for providing synchronization information for a train approaching a boundary between two hubs, each hub comprising a block processor and a hub radio interconnected via a first network, the hubs interconnected to one another via a second network, the train being disposed on a track for movement thereon and comprising a train radio connected to a train control system, each block processor within radio range of the train radio being configured to transmit information to the train control system, the method comprising:
determining by the train control system if the train is approaching a boundary between an upcoming hub and a current hub;
if the train is approaching the boundary, generating by the train control system a request message for synchronization information;
transmitting the request message by a hub radio of the current hub to a block processor of the upcoming hub;
obtaining the synchronization information from a hub radio of the upcoming hub;
transmitting the synchronization information by the block processor of the upcoming hub and the hub radio of the current hub to the train control system; and
synchronizing the train by the train control system with the hub radio in the upcoming cluster hub.

13. The method of claim 12, further comprising by the block processor of the upcoming hub combining the synchronization information with train control information and transmitting the combined information to the train control system.

14. The method of claim 13, wherein train control information comprises movement authorities for the train, speed restriction information for the upcoming hub, positions of other trains in the upcoming hub, or a combination thereof.

15. The method of claim 12, further comprising breaking communication by the train control system with the current hub upon synchronizing with the upcoming hub.

16. The method of claim 12, wherein the hub radio comprises a plurality of radios, wherein a master hub is selected from the plurality of radios for coordinating reception and transmission of messages between the respective block processor and one or more train radios within radio range of one or more radios within the hub.

17. A method for obtaining synchronization information for a train approaching a boundary between two hubs, each hub comprising a block processor and a hub radio interconnected via a first network, the hubs interconnected to one another via a second network, the train being disposed on a track for movement thereon and comprising a train radio connected to a train control system, each block processor within radio range of the train radio being configured to transmit information to the train control system, the method comprising:
receiving at the train control system a synchronization message pertaining to an upcoming hub from a hub radio in a current hub;
synchronizing to the upcoming hub by the train control system based upon the synchronization message; and
establishing communications by the train control system with a hub radio in the upcoming hub.

18. The method of claim 17, further comprising:
determining by the train control system that the train is approaching a boundary between the current hub and the upcoming hub; and
transmitting a request message for synchronization information by the train control system.

19. The method of claim 17, wherein the synchronization message comprises radio synchronization information.

20. A method for communicating synchronization information for a train approaching a boundary between two hubs, each hub comprising a block processor and a hub radio interconnected via a first network, the hubs interconnected to one another via a second network, the train being disposed on a track for movement thereon and comprising a train radio connected to a train control system, each block processor within radio range of the train radio being configured to transmit information to the train control system, the method comprising:
receiving at a current hub synchronization information pertaining to an upcoming hub from the upcoming hub;
transmitting a synchronization message comprising the synchronization information from a hub radio in the current hub to the train, the train disposed on a section of the track associated with the current hub; and
establishing communications between a hub radio in the upcoming hub and the train.

21. The method of claim 20, further comprising:
determining by the current hub that the train is approaching a boundary between the current hub and the upcoming hub; and
transmitting a request message for synchronization information by the current hub.

22. The method of claim 20, wherein the synchronization message comprises radio synchronization information.
